(19) United States
(12) Patent Application Publication
(10) Pub. No.: US 2017/0043862 A1
(43) Pub. Date: Feb. 16, 2017

(54) COMMAND DRIVEN ELECTRONIC SPEED CONTROLLER

(71) Applicant: Louis Alvin Lippincott, Los Altos, CA (US)

(72) Inventor: Louis Alvin Lippincott, Los Altos, CA (US)

(73) Assignee: Louis Alvin Lippincott, Los Altos, CA (US)

(21) Appl. No.: 14/827,091

(22) Filed: Aug. 14, 2015

(51) Int. Cl. B64C 13/50; B64C 27/08

(52) U.S. Cl. CPC B64C 13/50; B64C 27/08; B64C 2201/108

(57) ABSTRACT

An unmanned aerial vehicle (UAV) utilizing a command driven electronic speed controller (CD-ESC) is disclosed that incorporates methods addressing the safety and capability of electric UAVs. The disclosure describes and enables improved control and recovery of UAVs and several safety improvements for the operation of and maintenance of electric-flight UAVs. The improvements can be implemented in a fashion that allows for existing multi-rotor UAVs to be easily upgraded with the newer safety and capability features.

### CROSS-REFERENCE TO RELATED APPLICATIONS

This application claims the benefit of and priority to the following U.S. Provisional Patent Application No. 62/070,128 filed Aug. 15th, 2014 which is incorporated herein by reference in its entirety.

### COPYRIGHT NOTICE

A portion of the disclosure of this patent document contains material that is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE DISCLOSURE

This disclosure relates generally to unmanned aerial vehicles (UAV) and relates specifically to electric-flight multi-rotor unmanned aerial vehicles (UAVs). Additionally, the disclosure describes and enables improved control and recovery of UAVs and several safety improvements for the operation of and maintenance of electric-flight UAVs.

### BACKGROUND

Multi-rotor UAVs are gaining popularity with the private sector as well as the commercial sector. Advances in electronics have enabled multi-rotor UAVs that can fly miles from the operator while transmitting real-time video images back to the operator. Many hobbyists use the video capabilities, called first person view (FPV) to explore areas from perspectives that would be unavailable to them without UAVs with FPV. The ability to transmit video from great distances, plus the ability to hover in one spot have made multi-rotor UAVs useful for commercial applications as well, such as monitoring growth on a large vineyard, evaluation of construction sites, real-estate promotions, etc. Law enforcement agencies are starting to use multi-rotor UAVs for search and rescue missions and tracking criminals There are military applications for multi-rotor UAVs as well. The list of uses for multi-rotor UAVs is growing every day.

Most multi-rotor UAVs are based on electric flight. Typically, electric multi-rotor UAVs use multiple brushless motors with each motor controlled by an electronic speed controller (ESC). The electronic speed controllers are in turn controlled by a flight controller (FC). The flight controller (FC) receives radio signals from a transmitter held by the operator via an onboard radio receiver. Therefore, it's the operator who controls the flight path of the multi-rotor UAV. However, some multi-rotor UAVs are autonomous in that they can be programmed by an operator before flight time to fly to a predetermined location at a specified height and speed and then return. In either case, the flight controller (FC) communicates with each electronic speed controller (ESC) to control the rotational speed (i.e. thrust) of each brushless motor. The ability of the flight controller to control the thrust of each motor gives it control of the yaw, pitch, roll, height and speed of the multi-rotor UAV.

Because of standards dating back to the early days of radio controlled flight, the electronic speed controller (ESC) uses a pulse width modulation signaling protocol transmitted to it over one signal wire. The limitation of one, unidirectional signal wire to control the electronic speed controller (ESC) creates some serious issues as the technology for multi-rotor UAVs advances. One such issue is the throttle calibration that must take place between the flight controller (FC) and the electronic speed controller (ESC). The flight controller (FC) and the electronic speed controller (ESC) must agree on what pulse width on the signal wire indicates minimum throttle and what pulse width indicates maximum throttle. Since the UAV is typically powered on with the throttle on the transmitter set to minimum, a de facto standard has developed where the electronic speed controller (ESC) will go into calibration mode if it is powered on with the throttle set to maximum. In other words, if the ESC detects a full throttle pulse width on the signal wire when it is first powered on, it will enter into calibration mode. Obviously, powering on an ESC with full throttle signaling is a dangerous situation. Sometimes, the ESC fails to go into calibration mode and instead drives the attached motor to full speed, instantly. Because of this well-known failure mode, the operator is instructed to first remove the propellers from the motors before performing an ESC calibration operation. However, since this often means partially disassembling the UAV, this safety step is sometimes ignored. As a consequence, people have been seriously injured from a propeller that suddenly ramped up to full speed during an ESC calibration attempt.

Another issue with the limitation of one, unidirectional signal wire to control the electronic speed controller (ESC) is the inability to reverse the rotational direction of the motor. Being able to reverse each motor individually would give a multi-rotor UAV the ability to fly inverted or to flip over should it land upside down. In other words, the multi-rotor could self-right itself if needed to recover from an unexpected crash leaving it partially or fully inverted. The inability to reverse the rotational direction of the motors stems from the fact that a minimum pulse width to the ESC indicates minimum rotational speed (stopped) and a maximum pulse width indicates maximum rotational speed. There is no room for forward and backward on the signaling to the ESC. While some attempts to use the mid-point pulse width to indicate minimum rotational speed (stopped) have been proposed for multi-rotor UAVs, where wider pulses would indicate increased forward speed and narrower pulses would indicate increased reverse speed have been made, the approach is fraught with dangers. In addition, the requirement of a dead band near the mid-point and having less than half of the pulse width's dynamic range to control the speed of the motors yields a less stable multi-rotor UAV.

Accordingly, there exists a need for a multi-rotor UAV to include improved features which both addresses the safety, stability and capability of the multi-rotor UAV. Ideally, the improvements would be implemented in a fashion that allows for existing multi-rotor UAVs to be upgraded with the newer safety and capability features. The present disclosure addresses these and other needs.

### SUMMARY

Briefly and in general terms, the present disclosure is directed towards a multi-rotor unmanned aerial vehicle (UAV) equipped with new and improved command driven electronic speed controllers (CD-ESCs). The command driven electronic speed controllers (CD-ESCs) use the standard single wire, pulse width modulated, signaling protocol to control the rotational speed of the motor, the direction of the rotational speed, ESC calibration, as well as other features.

In one aspect of the command driven electronic speed controller (CD-ESC) the pulse width modulation of the signal is modulated in a specific and controlled, but otherwise unnatural, manner to indicate a command being sent to the command driven electronic speed controller (CD-ESC).

In one aspect of the command driven electronic speed controller (CD-ESC) the pulse width modulation of the signal is modulated in a specific and controlled manner, but otherwise impossible by the operator, to indicate a command being sent to the command driven electronic speed controllers (CD-ESCs).

In one aspect of the command driven electronic speed controller (CD-ESC) the pulse width modulation of the signal is modulated in a specific and controlled, but otherwise unnatural, manner to indicate a command being sent to the command driven electronic speed controllers (CD-ESCs) during actual flight of the unmanned aerial vehicle (UAV).

In one aspect of the multi-rotor unmanned aerial vehicle (UAV) equipped with command driven electronic speed controllers (CD-ESCs) the UAV is capable of inverted flight and/or self-righting after a crash.

According to one aspect, a disclosed embodiment provides methods of putting the CD-ESC into calibration mode in a safe manner via the use of specific commands to the CD-ESC.

Other features and advantages of the present disclosure will become apparent from the following detailed description, taken in conjunction with the accompanying drawings, which illustrate, by way of example, the principles of the disclosed embodiments.

### BRIEF DESCRIPTION OF THE DRAWINGS

FIG. 1A is a top view, depicting one embodiment of a multi-rotor unmanned aerial vehicle (UAV) utilizing four rotors;

FIG. 1B is a back view, depicting one embodiment of a multi-rotor unmanned aerial vehicle (UAV) utilizing four rotors;

FIG. 2A is a block diagram of the main electrical components for an embodiment of a multi-rotor unmanned aerial vehicle (UAV) utilizing four rotors;

FIG. 2B is a block diagram of a motor, command driven electronic speed controller (CD-ESC) and the flight controller (FC) for an embodiment of a multi-rotor unmanned aerial vehicle (UAV);

FIG. 3A is a timing diagram, depicting the minimum pulse width, mid-point pulse width and maximum pulse width signaling to the command driven electronic speed controller (CD-ESC);

FIG. 3B is a timing diagram, depicting two separate pulse width streams to an command driven electronic speed controller (CD-ESC);

FIG. 4 is a table of commands, depicting a sample list of commands for an embodiment of the command driven electronic speed controller (CD-ESC);

FIG. 5A illustrates a back view of a multi-rotor unmanned aerial vehicle (UAV) utilizing four rotors in an upright position;

FIG. 5B illustrates a back view of a multi-rotor unmanned aerial vehicle (UAV) utilizing four rotors in an inverted position transitioning to an upright position;

### DETAILED DESCRIPTION

A self-righting, multi-rotor, unmanned aerial vehicle (UAV) utilizing four rotors with four command driven electronic speed controllers (CD-ESCs) is described. In the following description, numerous specific details are set forth. However, it is understood that embodiments may be practiced without these specific details. In other instances, well-known materials, structures, and techniques have not been shown in detail in order not to obscure the understanding of this description.

The terms, “for example,” “e.g.,” “in one/another aspect,” “in one/another scenario,” “in one/another version,” “in some configurations,” “in some implementations,” “preferably,” “usually,” “typically,” “may,” and “optionally,” as used herein, are intended to be used to introduce non-limiting embodiments. Unless expressly stated otherwise, while certain references are made to certain example system components or services, other components and services may be used as well and/or the example components may be combined into fewer components and/or divided into further components.

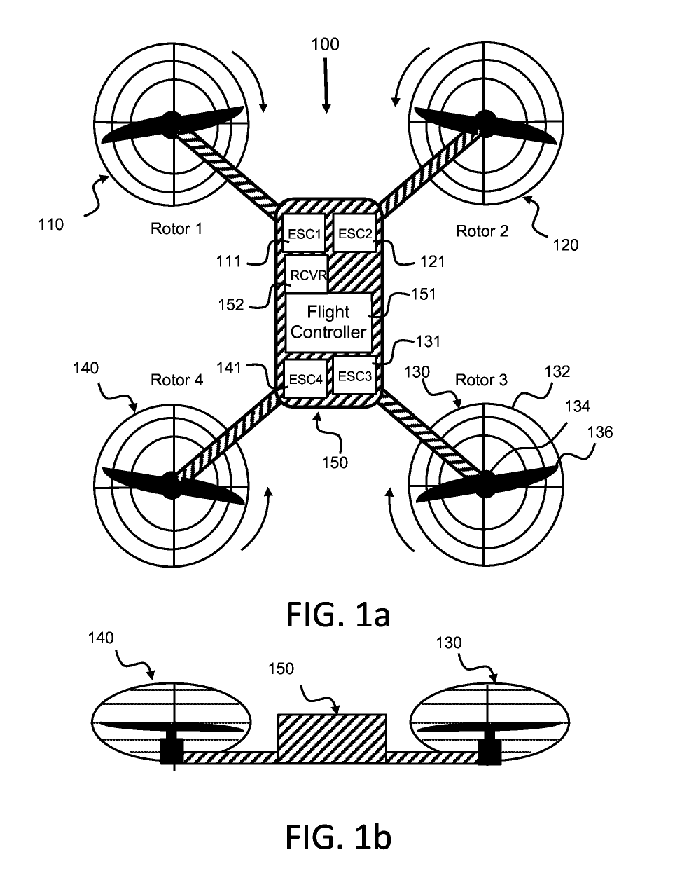

Turning now to the drawings, which are included by way of example and not limitation, the present disclosure is directed towards a self-righting, multi-rotor, unmanned aerial vehicle (UAV) utilizing four rotors with four command driven electronic speed controllers (CD-ESCs) 100. As shown in FIGS. 1A and 1B, a four rotor UAV 100 typically comprises four rotor assemblies 110, 120, 130 and 140; a motor in each rotor assembly 134; a propeller in each rotor assembly 136; and, in some implementations, a propeller protection means, shown as a cage 132. The self-righting, multi-rotor, unmanned aerial vehicle (UAV) also typically includes a flight controller (FC) 151; a command driven electronic speed controller (CD-ESC) for each rotor assembly 111, 121, 131 and 141; a radio frequency receiver 152; and a frame 150 housing the rotors and the electronics of the UAV.

Furthermore, in some embodiments the self-righting, multi-rotor, unmanned aerial vehicle (UAV) will utilize a different number of rotor assemblies.

Typically, opposing rotor assemblies will rotate the propellers in the same direction, which is opposite to adjacent rotor assemblies. In other words, in the illustrated example, Rotor-1 110 will rotate its propeller in the same direction, e.g. clockwise, as Rotor-3 130, while Rotor-2 120 will rotate its propeller in the opposite direction, e.g. counterclockwise, as will Rotor-4 140.

In a typical multi-rotor, unmanned aerial vehicle (UAV) the propellers that rotate counterclockwise are designed to direct the thrust downward to lift the vehicle when rotated in the counterclockwise direction, while the propellers that rotate clockwise are designed to direct the thrust downward to lift the vehicle when rotated in the clockwise direction. If the propellers are rotated in the opposite direction for which they were designed to rotate then the thrust will be directed in the opposite direction.

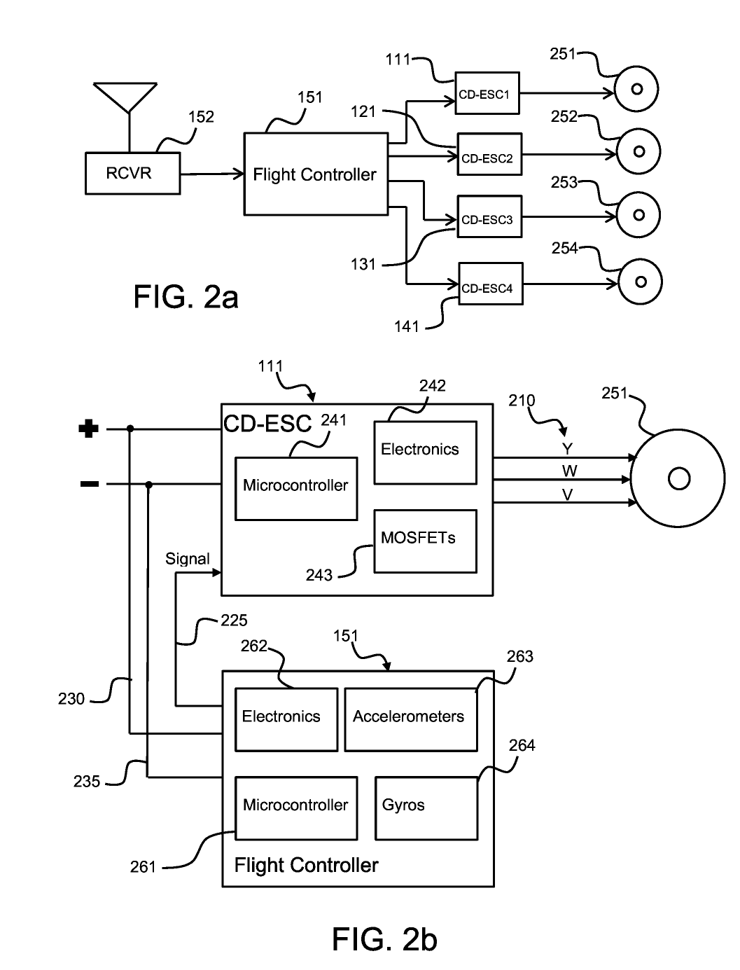

Referring now to FIG. 2A, in the preferred embodiment of the invention, the radio frequency receiver (RCVR) 152 directs received signals to the flight controller (FC) 151. The flight controller 151 interprets the received signals and computes rotational speed values for each of the four motors 251, 252, 253 and 254. The flight controller 151 converts the computed rotational speed values for each of the four motors into pulse widths to be sent to the four command driven speed controllers (CD-ESC) 111, 121, 131 and 141. Controlling the rotational speed of the four motors individually gives the UAV the ability to change yaw, pitch, roll, height and speed.

Referring now to FIG. 2B, a more detailed operation of the flight controller 151 and a single command driven electronic speed controller 111 with an associated motor 251 can be described. Battery power is directed to the flight controller 151 and a command driven electronic speed controller 111 through wires 230 and 235. The battery power is typically switched through MOSFETs 243 in the command driven electronic speed controller 111 through three wires (Y,W,V) 210. The switching of the battery voltage via the microcontroller 241 and electronics 242 through the MOSFETs 243 is done in a manner to cause the motor 251 to rotate. The motor 251 is typically wired as a three phase AC motor in either a wye or delta configuration. The order in which the phases are energized determines the direction of rotation of the motor 251. For example, driving the phases in the order of Y then W then V may cause the motor to rotate clockwise, while driving the phases in the order of V then W then Y may cause the motor to rotate counterclockwise. Often, the motors do not have the three phases labeled and after construction of the UAV it is sometimes necessary to switch two of the wires 210 to get the desired direction of rotation. This often requires de-soldering and re-soldering of the wires 210 to the electronic speed controller 111. As described later in this disclosure, the command driven electronic speed controller 111 eliminates this problem.

The microcontroller 241 in the command driven electronic speed controller 111 receives information from the flight controller 151. Typically this information is simply the required rotational speed of the attached motor 251. However, in the preferred embodiment of the invention, the flight controller 151 is also capable of sending commands to the command driven electronic speed controller 111 through the same signal wire 225. In the preferred embodiment of the invention, an analysis of the signal behavior on the signal wire 225 by the microcontroller 241 determines if the signal received is a request for rotational speed or a command to be executed by the command driven electronic speed controller 111. Rapid and extreme pulse width changes on the signal wire 225 would not happen in normal operation for flight of the UAV. In the preferred embodiment of the invention, rapid and extreme pulse width changes on the signal wire 225 would be interpreted by the microcontroller 241 as a command to be executed by the command driven electronic speed controller 111. If necessary, the command driven electronic speed controller 111 would maintain the current rotational speed of the motor 251 while a command is executed. Typically, commands would not be sent during actual flight of the UAV, but the described invention allows for them.

In the preferred embodiment of the invention, the flight controller 151 has one signal wire 225 for each command driven electronic speed controller 111 with which to communicate all information to each command driven electronic speed controller 111. Only one command driven electronic speed controller 111 and motor 251 are shown in FIG. 2B for clarity. As mentioned earlier, this signal 225 is a pulse width modulated signaling protocol used by the flight controller 151 to request a rotational speed of the attached motor 251 during typical flight of the UAV. The pulse width is updated and repeated many times a second. It can be repeated as low as 50 times a second or over 8000 times a second, depending on the specific implementation of the flight controller 151 and a command driven electronic speed controller 111.

The flight controller 151 typically has electronics 262 used to interface to an external device such as a personal computer (PC), not shown. For example, the flight controller 151 could be connected to a PC via a USB port, serial interface or some other interfacing means. While connected to the PC the user can calibrate the accelerometers 263 and gyroscopes 264, for example. In addition, the user could have the flight controller 151 send various commands to the command driven electronic speed controller 111 to set up minimum throttle level, maximum throttle level, default rotational direction and turn braking on or off, for example. Because the command driven electronic speed controller 111 can accept commands in a small fraction of a second, there is no dangerous process of giving full throttle to the electronic speed controller for an extended period of time, as is done in the prior art. Being able to change the default rotation direction with a command from the flight controller 151 would eliminate the need to reverse two of the wires 210 going to the motor 251 if the wiring caused the wrong rotational direction.

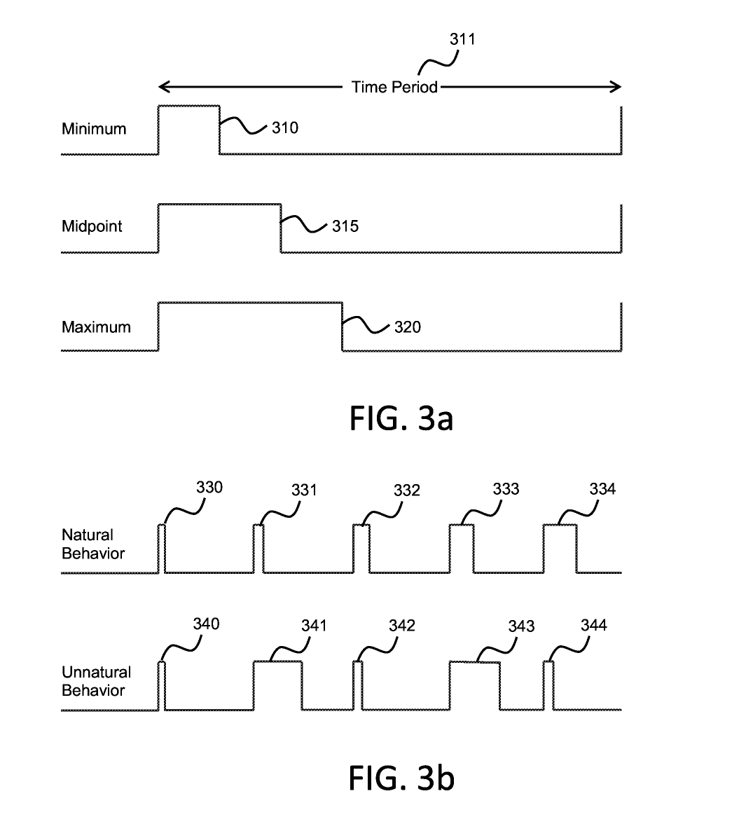

FIG. 3A depicts a timing diagram of a typical pulse width modulation (PWM) signaling protocol that would appear on the signal wire 225 going to a command driven electronic speed controller 111. In the preferred embodiment of the invention, the timing will always include a time period 311 in which the timing pulse repeats itself, a minimum pulse width 310 and a maximum pulse width 320. In another embodiment of the invention, the timing may include additional pulse widths, such as less-than-minimum pulse width and more-than-maximum pulse width. The less-than-minimum pulse width and more-than-maximum pulse width signaling would be used only during command phases of the signaling protocol.

FIG. 3A also shows the midpoint 315 timing. In this example, the time period 311 is 5 milliseconds, the minimum pulse width 310 is 1 millisecond, the midpoint pulse width 315 is 1.5 milliseconds and the maximum pulse width 320 is 2 milliseconds. If the timing diagram in FIG. 3A was representing the throttle signal (rotational speed request) to the command driven electronic speed controller 111, then the minimum pulse width 310 would represent the minimum speed of the attached motor (stopped), the midpoint pulse width 315 would represent half speed, which may be the speed at which the UAV hovers and the maximum pulse width 320 would represent full speed rotation of the attached motor.

FIG. 3B depicts timing diagrams of what is considered natural behavior of the PWM signal and unnatural behavior of the PWM signal. During natural behavior the pulse width changes are slower and less drastic. For example, during takeoff of the UAV the pulse width 330 may be the minimum pulse width. Pulse width 330 would be followed by a pulse width 331 that is slightly longer, which is followed by a pulse width 332 that is slightly longer than pulse width 331, which is followed by a pulse width 333 that is slightly longer than pulse width 332 and so on until the desired rotational speed is reached.

During unnatural behavior the pulse width changes are more drastic. For example, the minimum pulse width 340 might be followed by a maximum pulse width 341, which would be followed by a minimum pulse width 342, which would be followed by a maximum pulse width 343. It would be physically impossible for an operator of a UAV to move the throttle stick on the transmitter from minimum to maximum and back within a small number of milliseconds. Such unnatural behavior would be ignored as rotational requests and would instead put the command driven electronic speed controller 111 into command mode. In command mode, the command driven electronic speed controller 111 would maintain the speed of the motor requested before the command mode signaling was sent and accept the next several pulse widths as command identifier bits before executing the command and exiting the command mode. For example, the next four pulses could be interpreted as the command identifier, where a minimum pulse width is a zero and a maximum pulse width is a one. The four bit command identifier would indicate which command out of 16 possible commands would get executed. Once the command has been identified, the command driven electronic speed controller 111 would return to normal operation or execute the command received.

Before the minimum and maximum pulse widths have been calibrated the command driven electronic speed controller 111 will have to detect unnatural behavior correctly. Jitter, i.e. rapid, but slight, changes of the pulse width occur naturally due to radio frequency interference, sampling errors in the transmitter and receiver, etc. In the preferred embodiment of the invention, the timing changes would be ignored for command detection unless they exceeded some percentage value of the smallest pulse width received. As an example, the command driven electronic speed controller 111 may ignore changes less than 70% of the minimum pulse width detected for command detection. Both jitter in the pulse widths and legitimate speed corrections for the motors would be well under 70% of the minimum pulse width detected. However, if a legitimate command was sent, the pulse width changes would be well over 70% of the minimum pulse widths. The 70% value is used as an example and would work for most implementations, but values other than 70% would also work and may be better for some specific or unusual implementations.

For higher update rates where the pulse repetition rate is high the unnatural behavior in the pulse stream may include a number of pulses of minimum or near minimum pulses followed by a number of pulses of maximum or near maximum pulses. The command driven electronic speed controller 111 would calculate the expected number of pulses for bits coming later in the command in order to handle multiple ones or zeros in succession during the command identifier.

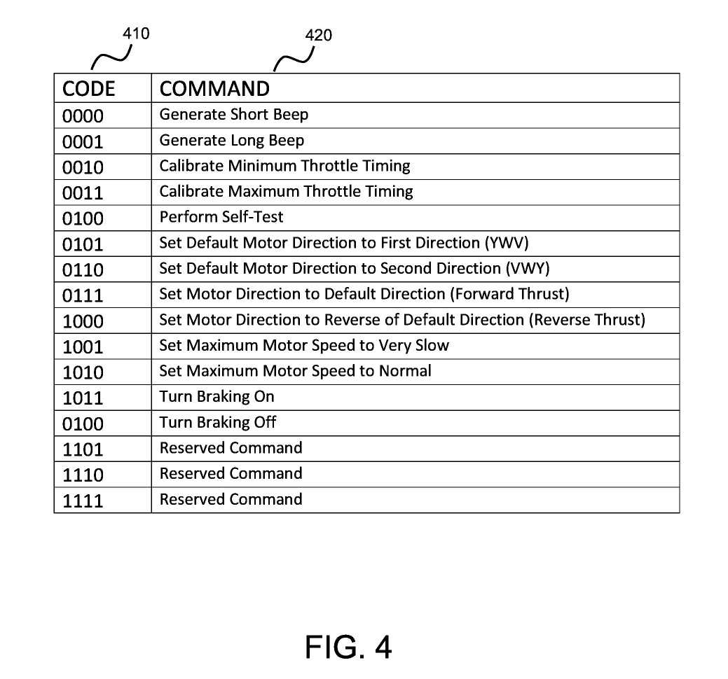

Referring now to FIG. 4, an example list of commands that a command driven electronic speed controller might support is shown. The table in FIG. 4 shows two columns, one for the command identifier codes 410 and one for the specific command 420 to be executed. Of notable interest is the Calibrate Maximum Throttle Timing command. In the preferred embodiment of the invention, because minimum and maximum pulse widths are used to send commands, it is possible to have the command driven electronic speed controller 111 accurately measure the maximum pulse width while the command is being sent and use that value to calibrate the pulse width for maximum throttle. The same is true for minimum pulse width. Once the minimum and maximum pulse widths have been calibrated, the command driven electronic speed controller 111 can map all pulse width values from minimum to maximum as rotational speeds for the motor from stopped to full speed, respectively. Typically, the command driven electronic speed controller 111 would store the calibrated values for minimum and maximum pulse widths in non-volatile RAM, such as Flash memory.

The Set Default Motor Direction to First Direction (YWV) and the Set Default Motor Direction to Second Direction (VWY) can be used to reverse the normal (default) rotational direction of the motor after construction. Having the ability to change the default rotational direction of the motors would negate the need to reverse two of the motor wires should the motor turn in the wrong direction after being soldered to the command driven electronic speed controller 111. For example, if rotor-1 110 was intended to turn clockwise, but turns counterclockwise after the motor wires are soldered to the command driven electronic speed controller 111, then the Set Default Motor Direction to Second Direction (VWY) can be used to reverse the motor and have rotor-1 110 turn clockwise during normal operation. Typically, the command driven electronic speed controller 111 would store the default direction value (first or second) in non-volatile RAM, such as Flash memory.

The Set Motor Direction to Default Direction and the Set Motor Direction to Reverse of Default Direction can be used to reverse the direction of the motor during operation of the UAV. Having the ability to reverse the direction of the motors would allow the UAV to fly inverted, for acrobatic maneuvers, or have the UAV self-right itself if it lands upside down.

The Set Maximum Motor Speed to Very Slow and Set Maximum Motor Speed to Normal can be used to test the motor direction after construction without having to attempt to fly the UAV. When the motors are set to very slow as their maximum speed it will be possible to safely observe the rotational direction of the motors without any danger of the UAV behaving erratically.

It will be apparent from the foregoing that, while particular commands have been illustrated and described, various other commands or subsets of the commands shown could be implemented without parting from the spirit and scope of the disclosure.

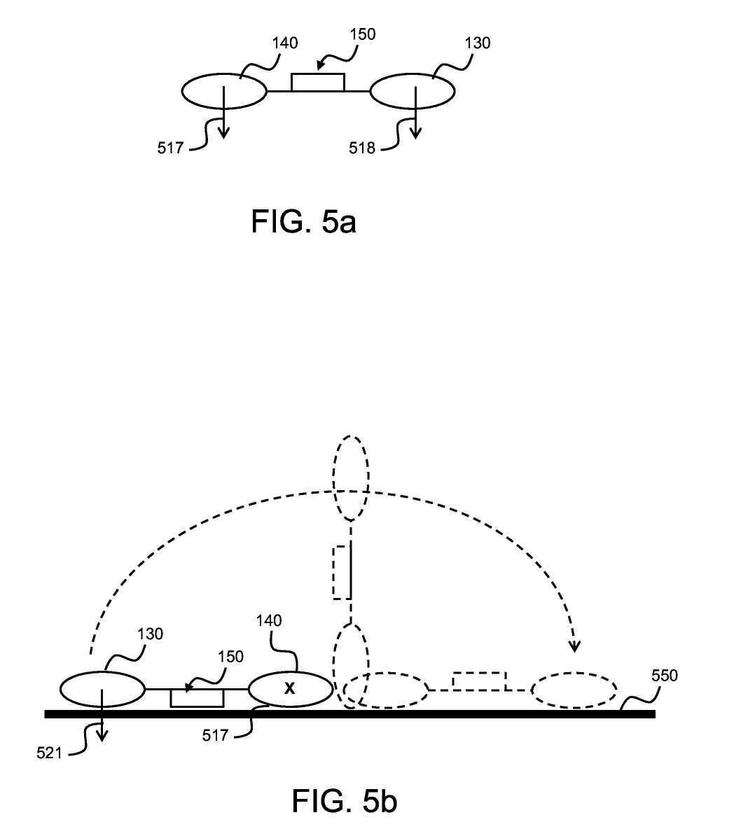

FIG. 5A shows the rear view of a UAV in normal flight. The diagram is a simplified version of the UAV shown in FIG. 1B. In normal flight the thrust is directed downwards from the left and right of the UAV, as well as the front and back of the UAV. Since we are observing the rear of the UAV we can see only the left rear rotor 140 with its corresponding downward thrust 517 and the right rear rotor 130 with its corresponding downward thrust 518. The flight controller housed in the frame 150 can detect the orientation of the UAV via its accelerometers and gyros, knows that it is upright and keeps the motors turning in their normal direction. As mentioned earlier, slight modifications to the speed of the individual motors will allow the UAV to move around in 3D space.

FIG. 5B shows the rear view of the same UAV on the ground 550 in an inverted position, perhaps from an unintended crash. Inverted, the right rear rotor 130 appears on the left and the left rear rotor 140 appears on the right. The flight controller housed in the frame 150 can detect the orientation of the UAV via its accelerometers and gyros and knows that it is upside down. In order to self-right itself the UAV may stop the rotation of the left rotors to stop the thrust 517 on that side of the UAV while reversing the thrust 521 on the right rotors. This action would cause the AUV to flip over from left to right as is shown in the diagram. As the UAV is flipping over it may decrease or even reverse the thrust again in order to set the upright UAV down gently.

In the preferred embodiment of the invention, the UAV would attempt other flip maneuvers if previous attempts were unsuccessful. For example, the UAV may try to flip over left to right as shown in the diagram. If unsuccessful, perhaps because of a blockage over its left side, it may try to flip over right to left, or front to back, or back to front. In addition, by repeatedly flipping over in the same direction, the UAV could “walk” out of a situation before attempting to fly. Naturally, another strategy for the UAV would be to fly off inverted until well in the air and then self-right itself.

It will be apparent from the foregoing that, while particular forms of the disclosure have been illustrated and described, various modifications can be made without parting from the spirit and scope of the disclosure.

Furthermore, the various embodiments described above are provided by way of illustration only and should not be construed to limit the invention. For example, while described as a multi-rotor UAV, embodiments are not so limited. Essentially all electric vehicles controlled by an ESC (electronic speed controller) need to be calibrated for minimum and maximum throttle and could benefit from the command driven electronic speed controller. As an example, an electric airplane could be calibrated without setting the throttle control to full speed by utilizing the capabilities of the command driven electronic speed controller. Those skilled in the art will readily recognize various modifications and changes that may be made to the disclosed invention without following the example embodiments and applications illustrated and described herein.

I claim:

1. A command driven electronic speed controller utilizing one active signal wire wherein the pulse width modulation of the signal is modulated in a specific and controlled, but otherwise unnatural manner to indicate a command being sent to the command driven electronic speed controller over said signal wire.

2. The system and method of claim 1 wherein said unnatural manner is a series of alternating substantially minimum and substantially maximum pulses of said pulse width modulated signal.

3. The system and method of claim 1 wherein said unnatural manner is a series of alternating numbers of pulses of substantially minimum and substantially maximum pulses of said pulse width modulated signal.

4. The system and method of claim 1 wherein said unnatural manner is a series of substantially minimum and substantially maximum pulses of said pulse width modulated signal that would be impossible by a human operator to emulate directly.

5. A command driven electronic speed controller utilizing one active signal wire wherein the pulse width modulation of the signal is modulated in a specific and controlled, but otherwise unnatural manner to indicate a command being sent to the command driven electronic speed controller over said signal wire during actual flight of an unmanned aerial vehicle.

6. The system and method of claim 5 wherein said unnatural manner is a series of alternating substantially minimum and substantially maximum pulses of said pulse width modulated signal.

7. The system and method of claim 5 wherein said unnatural manner is a series of alternating numbers of pulses of substantially minimum and substantially maximum pulses of said pulse width modulated signal.

8. The system and method of claim 5 wherein said unnatural manner is a series of substantially minimum and substantially maximum pulses of said pulse width modulated signal that would be impossible by a human operator to emulate directly.

9. A command driven electronic speed controller utilizing one active signal wire wherein the pulse width modulation of the signal is modulated in a specific and controlled, but otherwise unnatural manner to put the command driven electronic speed controller into a calibration mode in a safe manner by quickly returning to a steady state of minimum pulse widths on said signal wire.

10. The system and method of claim 9 wherein said unnatural pulse width modulation is a series of alternating substantially minimum and substantially maximum pulses of said pulse width modulated signal.

11. The system and method of claim 9 wherein said unnatural pulse width modulation is a series of alternating numbers of pulses of substantially minimum and substantially maximum pulses of said pulse width modulated signal.

12. The system and method of claim 9 wherein said unnatural pulse width modulation is a series of substantially minimum and substantially maximum pulses of said pulse width modulated signal that would be impossible by a human operator to emulate directly.
